(19) United States
(12) Patent Application Publication
(10) Pub. No.: US 2016/0138319 A1
(43) Pub. Date: May 19, 2016

(54) Secure Assembly Structure For Furniture Hinge Buffer Device

(71) Applicant: Zhiyong Wu, Leliu (CN)

(72) Inventor: Zhiyong Wu, Leliu (CN)

(21) Appl. No.: 14/797,809

(22) Filed: Jul. 13, 2015

(30) Foreign Application Priority Data
Nov. 17, 2014 (CN) 201410652206.2

(51) Int. Cl. E05F 3/20; E05D 3/02

(52) U.S. Cl. CPC E05F 3/20; E05D 3/02

(57) ABSTRACT

A secure assembly structure for a furniture hinge buffer device is disclosed, comprising a movable hinge cup coupled to a furniture door panel, a securing member coupled to a furniture wall panel, a hinge arm configured to couple the movable hinge cup and the securing member, and an elastic member acting on the hinge arm; wherein the movable hinge cup is provided with a concave portion, the concave portion being provided with a buffer device, the buffer device comprising a buffer and a positioning member; wherein the positioning member is provided with a securing portion and is disposed on the concave portion via the securing portion, and the buffer is slidably positioned on the positioning member and/or the concave portion.

### CROSS-REFERENCE TO RELATED APPLICATIONS

The present application claims priority from Chinese Application No. 201410652206.2 filed Nov. 17, 2014, the disclosure of which is hereby incorporated herein by reference.

### TECHNICAL FIELD

The present invention relates to a furniture hinge, and more particularly to a secure assembly structure for a furniture hinge buffer device.

### BACKGROUND

Chinese Patent Application No. CN201339380 published on Jan. 9, 2009 has disclosed a hinge, comprising door box, a coupling rod, a hinge arm, a movable arm, a base, a buffer, a torsion spring, a linker, and a lever drive tab. The linker is a fan-shaped structure, which comprises one center hole and three circumferential holes. The linker is movably coupled and positioned to the hinge arm via the center hole, and is movably coupled to a piston rod end of the buffer via one circumferential hole. The remaining two circumferential holes are provided with axles. The lever drive tab is provided with an end hole and an intermediate hole. The other end opposite to the end hole is provided with two fork tooth openings. The lever drive tab is movably coupled to the hinge arm via the intermediate hole, such that the two fork tooth openings are meshed with the axles on the circumferential hole of the linker. The other end of the lever drive tab is movably coupled to the door box via the end hole. The torsion spring is assembled on the coupling rod, and presses tightly the hinge arm, the coupling rod and the door box and provides an opening/closing state for the door box relative to the hinge arm. It is reported that the hinge is simple in structure, reliable in performance, and flexible in usage. However, due to the effect of the buffer, with the hinge, the door may be opened or closed with a greater force, which tends to cause damages to the handle on the door or cause the door not to be closed securely. In addition, assembling of the buffer is extremely inconvenient, failing to accommodate the usage requirements of the users. Therefore, some improvements are desired.

### SUMMARY

The present invention is directed to providing a secure assembly structure for a furniture hinge buffer device, which has the advantages of simple structure, reliable performance, low manufacture cost, smooth opening and closing, low noise, safe and convenient transportation and usage, and high practicability, to overcome the defects in the related art.

In view of the above objective, a secure assembly structure for a furniture hinge buffer device is designed, comprising a movable hinge cup coupled to a furniture door panel, a securing member coupled to a furniture wall panel, a hinge arm configured to couple the movable hinge cup and the securing member, and an elastic member acting on the hinge arm; wherein the movable hinge cup is provided with a concave portion, the concave portion being provided with a buffer device, the buffer device comprising a buffer and a positioning member; wherein the positioning member is provided with a securing portion and is disposed on the concave portion via the securing portion, and the buffer is slidably positioned on the positioning member and/or the concave portion.

The buffer is a self-resetting buffer and comprises at least a spring and a cylinder body, the spring being elastically loaded on the cylinder body; the hinge arm acts on and pushes the buffer to slide at least when the hinge is closed, such that the buffer acts on a side wall of the concave portion and an effective stroke of the buffer is reduced, exerting a buffer effect, and the buffer resets the effective stroke via the action of the spring when the hinge is opened, and stays in a standby state.

The securing portion of the positioning member is a columnar plastic article and more than one securing portion is provided, and corresponding to the securing portions, securing holes with the equivalent shape and quantity are disposed on the bottom of the concave portion of the movable hinge cup; the positioning member is top-to-bottom inserted into the securing hole of the concave portion via the securing portion, and the securing portion is riveted such that the positioning member is secured to the movable hinge cup.

The positioning member and the securing portion are formed into an integral plastic article, the positioning member is provided with a positioning portion, and the securing portion is disposed on the positioning portion; the securing portion is inserted into the securing hole, the positioning portion is borne on the bottom of the concave portion, and the securing portion is riveted on the movable hinge cup; the movable hinge cup and/or the positioning member are each provided with a guiding groove, the buffer is provided with a guiding portion and is forward-to-backward slidably positioned on the guiding groove via the guiding portion to prevent the buffer from being detached from the movable hinge cup and/or the positioning member.

The buffer is provided with a limiting portion, corresponding to the limiting portion, the positioning member and/or the concave portion are each provided with a limiting mating portion, and the buffer, when sliding to at least one position, is limited on the limiting mating portion of the positioning member and/or the concave portion via the limiting portion to prevent the buffer from being detached from the movable hinge cup and/or the positioning member.

The concave portion of the movable hinge cup is provided with a step, and the securing portion of the positioning member is riveted and secured to the step.

The securing portion and the positioning portion are left-to-right disposed on the positioning member and more than one securing portion or positioning portion is disposed, the securing hole and the step are left-to-right disposed on the concave portion and more than one securing hole or step are disposed; wherein the securing portion is left-to-right riveted on the securing hole, and the positioning portion is borne on the left-to-right disposed step.

The movable hinge cup and the positioning member are each provided with the guiding groove, the buffer is provided with the guiding portion and is forward-to-backward slidably positioned on the guiding groove via the guiding portion; wherein the securing hole is disposed on the bottom of an outer side wall of the guiding groove of the movable hinge cup.

The hinge arm is hinged to the movable hinge cup and is provided with an action surface which acts on the buffer at least when the hinge is closed; the positioning member is disposed on the buffer and provided with a damper switch member in a rotation or swinging manner, and a buffer stroke of the damper is restricted and/or restored by rotating or swinging the damper switch member when the hinge is opened and/or closed.

The elastic member is a metal torsion spring, one end of the elastic member is disposed on the movable hinge cup, and the other end of the elastic member is crimped on a crimping portion of the hinge arm; a flexible material member is disposed on a region where an intermediate portion of the elastic member is in contact with the movable hinge cup, wherein the flexible material member eliminates the force applied by the intermediate portion of the elastic member onto the movable hinge cup and the noise generated by longitudinal movement of the elastic member relative to the movable hinge cup when the hinge is opened and/or closed.

According to the present invention, with the above improvements of the structure, the positioning member is provided with a securing portion and is top-to-bottom inserted into the securing hole of the concave portion \ via the securing portion, and the securing portion is riveted such that the positioning member is secured to the movable hinge cup. By means of non-elastic clamping securing manner and non-detachable elastic coupling, the securing portion is directly disposed on the positioning member, and the positioning member is riveted and secured to the movable hinge cup via the securing portion, such that the buffer device can be more securely assembled on the movable hinge cup, to prevent the buffer from being detached from the movable hinge cup. In addition, steps are disposed on left and right sides of the movable hinge cup, which effectively ensure the thickness of the movable hinge cup and improve the service life of the movable hinge cup. Further, the positioning member is borne via the positioning portion on the left and right steps of the movable hinge cup, and then inserted and riveted and secured to the left and right securing holes of the movable hinge cup. The positioning member is riveted on the exterior of the movable hinge cup and the steps may prevent contact or collision between the riveting position of the positioning member and the movable hinge cup, and other objects. During transportation, conveying, and use of the structure by users, this further effectively prevents the buffer device from being detached from the movable hinge cup, such that the users can use the structure more safely and conveniently. The secure assembly structure has the advantages of simple structure, reliable performance, low manufacture cost, smooth opening and closing, low noise, safe and convenient transportation and usage, and high practicability.

### BRIEF DESCRIPTION OF THE DRAWINGS

FIG. 1 is an exploded schematic structural view of a first embodiment of the present invention;

FIG. 2 is a schematic structural view of the first embodiment of the present invention;

FIG. 3 is another schematic structural view of the first embodiment of the present invention;

FIG. 4 is a schematic structural top view of the first embodiment of the present invention;

FIG. 5 is a schematic structural sectional view taken along A-A line in FIG. 4;

FIG. 6 is a schematic structural sectional view taken along B-B line in FIG. 4;

FIG. 7 and FIG. 8 are schematic structural views of a movable hinge cup according to the present invention; and

FIG. 9 is a schematic structural view of a positioning member according to the present invention.

### DETAILED DESCRIPTION

The present invention is further described with reference to the accompanying drawings and exemplary embodiments.

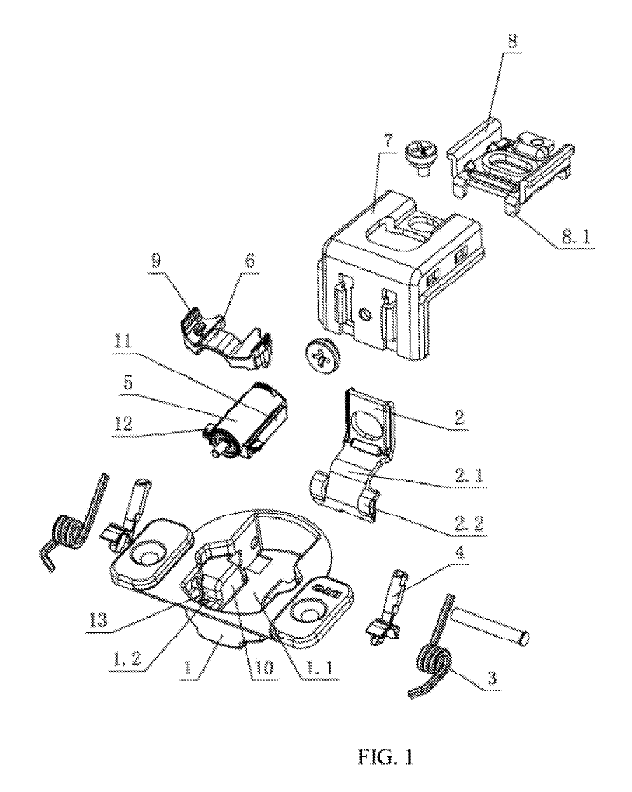

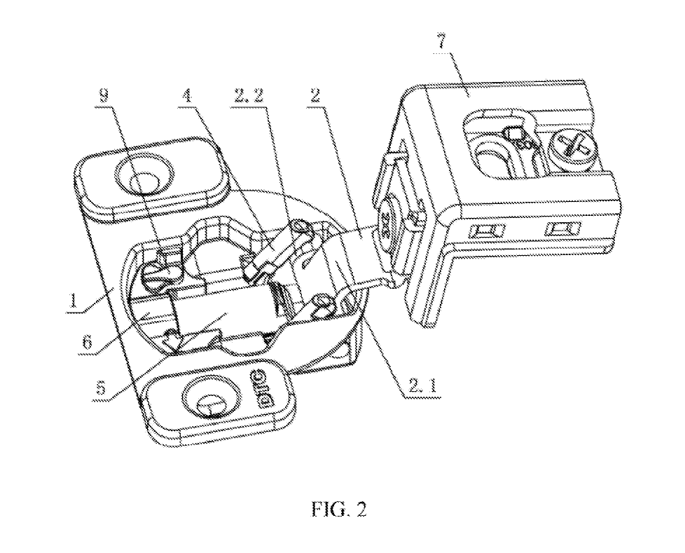

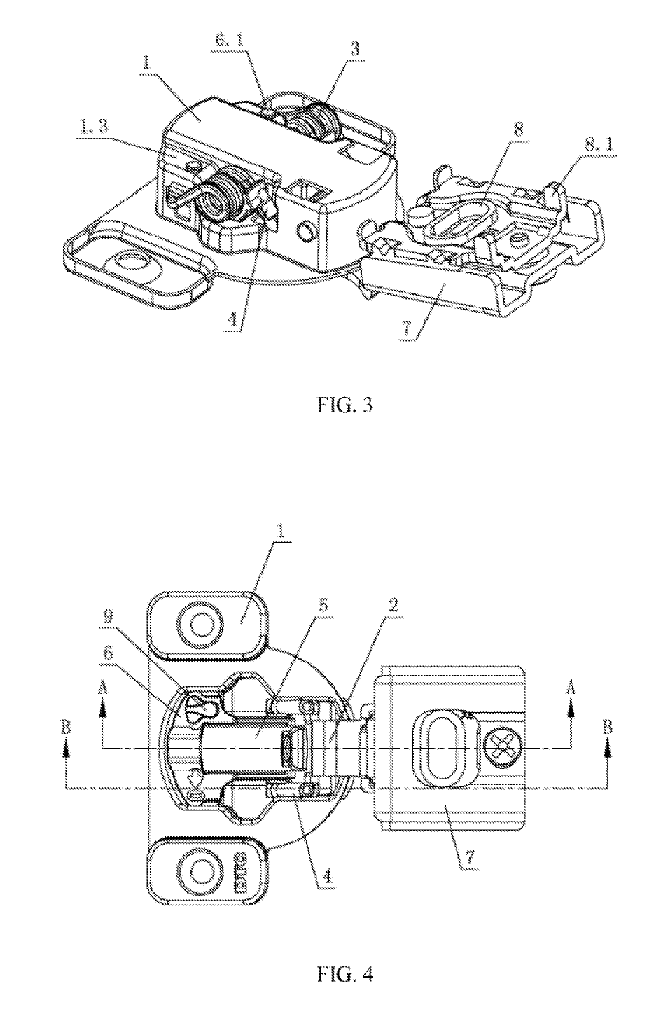

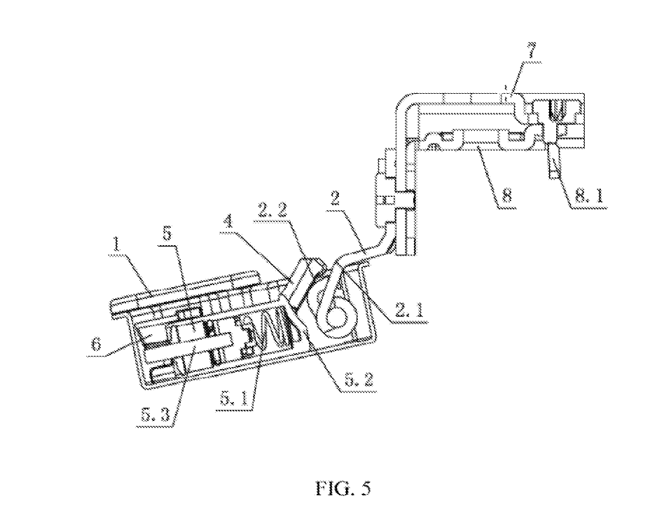

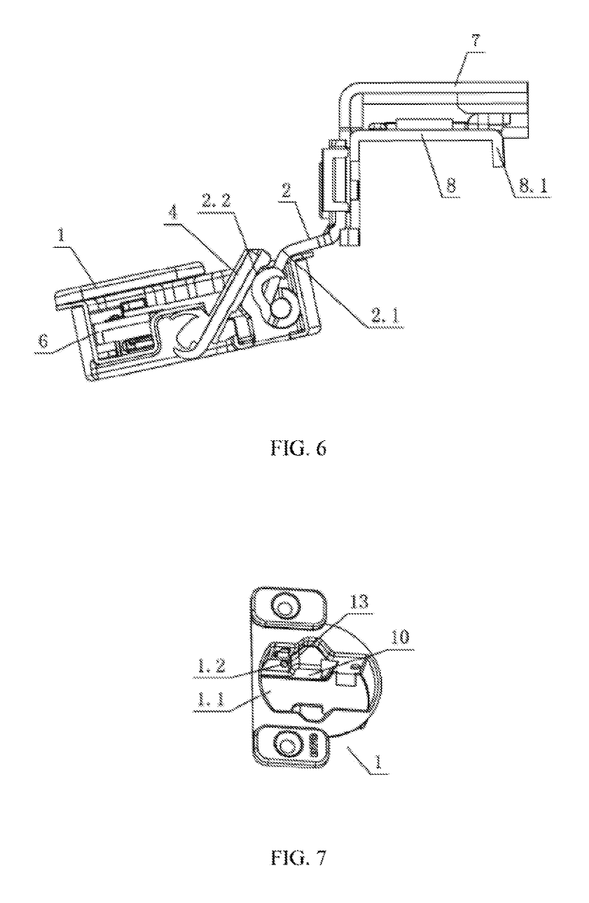

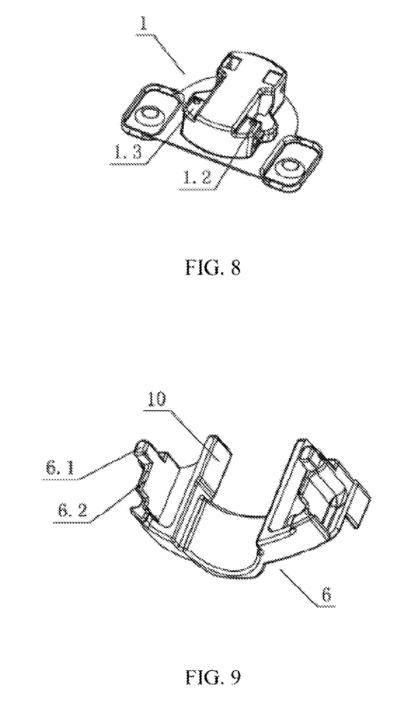

Referring to FIG. 1 to FIG. 9, a secure assembly structure for a furniture hinge buffer device is illustrated, comprising a movable hinge cup 1 coupled to a furniture door panel, a securing member 8 coupled to a furniture wall panel, a hinge arm 2 configured to couple the movable hinge cup 1 and the securing member 8, and an elastic member 3 acting on the hinge arm 2; wherein the movable hinge cup 1 is provided with a concave portion 1.1, the concave portion 1.1 being provided with a buffer device, the buffer device comprising a buffer 5 and a positioning member 6; wherein the positioning member 6 is provided with a securing portion 6.1 and is disposed on the concave portion 1.1 via the securing portion 6.1, and the buffer 5 is slidably positioned on the positioning member 6 and/or the concave portion 1.1.

The buffer 5 is a self-resetting buffer and comprises at least a spring 5.1 and a cylinder body 5.2, the spring 5.1 being elastically loaded on the cylinder body 5.2; the hinge arm 2 acts on and pushes the buffer 5 to slide at least when the hinge is closed, such that the buffer 5 acts on a side wall of the concave portion 1.1 and an effective stroke of the buffer 5 is reduced, exerting a buffer effect, and the buffer 5 resets the effective stroke via the action of the spring 5.1 when the hinge is opened, and stays in a standby state.

The securing portion 6.1 of the positioning member 6 is a columnar plastic article and more than one securing portion 6.1 is provided, and corresponding to the securing portions 6.1, securing holes 1.2 with the equivalent shape and quantity are disposed on the bottom of the concave portion 1.1 of the movable hinge cup 1; the positioning member 6 is top-to-bottom inserted into the securing hole 1.2 of the concave portion 1.1 via the securing portion 6.1, and the securing portion 6.1 is riveted such that the positioning member 6 is secured to the movable hinge cup 1. The positioning member 6 and the securing portion 6.1 are formed into an integral plastic article, the positioning member 6 is provided with a positioning portion 6.2, and the securing portion 6.1 is disposed on the positioning portion 6.2; the securing portion 6.1 is inserted into the securing hole 1.2, the positioning portion 6.2 is borne on the bottom of the concave portion 1.1, and the securing portion 6.1 is riveted on the movable hinge cup 1; the movable hinge cup 1 and/or the positioning member 6 are each provided with a guiding groove 10, the buffer 5 is provided with a guiding portion 11 and is forward-to-backward slidably positioned on the guiding groove 10 via the guiding portion 11 to prevent the buffer 5 from being detached from the movable hinge cup 1 and/or the positioning member 6.

The buffer 5 is provided with a limiting portion 12, corresponding to the limiting portion 12, the positioning member 6 and/or the concave portion 1.1 are each provided with a limiting mating portion 13, and the buffer 5, when sliding to at least one position, is limited on the limiting mating portion 13 of the positioning member 6 and/or the concave portion 1.1 via the limiting portion 12 to prevent the buffer 5 from being detached from the movable hinge cup 1 and/or the positioning member 6. The concave portion 1.1 of the movable hinge cup 1 is provided with a step 1.3, and the securing portion 6.1 of the positioning member 6 is riveted and secured to the step 1.3.

The securing portion 6.1 and the positioning portion 6.2 are left-to-right disposed on the positioning member 6 and more than one securing portion 6.1 or positioning portion 6.2 is disposed, the securing hole 1.2 and the step 1.3 are left-to-right disposed on the concave portion 1.1 and more than one securing hole 1.2 or step 1.3 is disposed; wherein the securing portion 6.1 is left-to-right riveted on the securing hole 1.2, and the positioning portion 6.2 is borne on the left-to-right disposed step 1.3. The movable hinge cup 1 and the positioning member 6 are each provided with the guiding groove 10, the buffer 5 is provided with the guiding portion 11 and is forward-to-backward slidably positioned on the guiding groove 10 via the guiding portion 11; wherein the securing hole 1.2 is disposed on the bottom of an outer side wall of the guiding groove 10 of the movable hinge cup 1.

The riveting is preferably hot riveting, ultrasonic wave riveting, rotary riveting, hot melting, or the like.

In the above structure, one end of the hinge arm 2 is hinged to the movable hinge cup 1, and the other end of the hinge arm 2 is adjustably connected to a regulating cover plate 7 via an eccentric part, wherein an action surface 2.1 of the hinge arm 2 acts on the buffer 5 at least when the hinge is closed; the securing member 8 is disposed on the regulating cover plate 7 and is provided with a plurality of support legs 8.1 disposed on the furniture wall panel; the positioning member 6 is disposed on the buffer 5 and is provided with a damper switch member 9 in a rotation or swinging manner, wherein a buffer stroke of the damper 5 is restricted and/or restored by rotating or swinging the damper switch member 9 when the hinge is opened and/or closed. The elastic member 3 is a metal torsion spring, one end of the elastic member 3 is disposed on the movable hinge cup 1, and the other end of the elastic member 3 is crimped on a crimping portion 2.2 of the hinge arm 2; a flexible material member 4 is disposed on a region where an intermediate portion of the elastic member 3 is in contact with the movable hinge cup 1, wherein the flexible material member 4 eliminates the force applied by the intermediate portion of the elastic member 3 onto the movable hinge cup 1 and the noise generated by longitudinal movement of the elastic member 3 relative to the movable hinge cup 1 when the hinge is opened and/or closed.

Described above are preferred solutions of the present invention. All simple variations or modifications made to the preferred solutions by persons of ordinary skill in the art shall be construed as falling within the protection scope of the present invention.

What is claimed is:

1. A secure assembly structure for a furniture hinge buffer device, comprising a movable hinge cup coupled to a furniture door panel, a securing member coupled to a furniture wall panel, a hinge arm configured to couple the movable hinge cup and the securing member, and an elastic member acting on the hinge arm; wherein the movable hinge cup is provided with a concave portion, the concave portion being provided with a buffer device, the buffer device comprising a buffer and a positioning member; wherein the positioning member is provided with a securing portion and is disposed on the concave portion via the securing portion, and the buffer is slidably positioned on the positioning member and/or the concave portion.

2. The secure assembly structure for a furniture hinge buffer device according to claim 1, wherein the buffer is a self-resetting buffer and comprises at least a spring and a cylinder body, the spring being elastically loaded on the cylinder body; the hinge arm acts on and pushes the buffer to slide at least when the hinge is closed, such that the buffer acts on a side wall of the concave portion and an effective stroke of the buffer is reduced, exerting a buffer effect, and the buffer resets the effective stroke via the action of the spring when the hinge is opened, and stays in a standby state.

3. The secure assembly structure for a furniture hinge buffer device according to claim 2, wherein the securing portion of the positioning member is a columnar plastic article and more than one securing portion is provided, and corresponding to the securing portions, securing holes with the equivalent shape and quantity are disposed on the bottom of the concave portion of the movable hinge cup; the positioning member is top-to-bottom inserted into the securing hole of the concave portion via the securing portion, and the securing portion is riveted such that the positioning member is secured to the movable hinge cup.

4. The secure assembly structure for a furniture hinge buffer device according to claim 3, wherein the positioning member and the securing portion are formed into an integral plastic article, the positioning member is provided with a positioning portion, and the securing portion is disposed on the positioning portion; the securing portion is inserted into the securing hole, the positioning portion is borne on the bottom of the concave portion, and the securing portion is riveted on the movable hinge cup; the movable hinge cup and/or the positioning member are each provided with a guiding groove, the buffer is provided with a guiding portion and is forward-to-backward slidably positioned on the guiding groove via the guiding portion to prevent the buffer from being detached from the movable hinge cup and/or the positioning member.

5. The secure assembly structure for a furniture hinge buffer device according to claim 4, wherein the buffer is provided with a limiting portion, corresponding to the limiting portion, the positioning member and/or the concave portion are each provided with a limiting mating portion, the buffer, when sliding to at least one position, is limited on the limiting mating portion of the positioning member and/or the concave portion via the limiting portion to prevent the buffer from being detached from the movable hinge cup and/or the positioning member.

6. The secure assembly structure for a furniture hinge buffer device according to claim 5, wherein the concave portion of the movable hinge cup is provided with a step, and the securing portion of the positioning member is riveted and secured to the step.

7. The secure assembly structure for a furniture hinge buffer device according to claim 6, wherein the securing portion and the positioning portion are left-to-right disposed on the positioning member and more than one securing portion or positioning portion is disposed, the securing hole and the step are left-to-right disposed on the concave portion and more than one securing hole or step is disposed; wherein the securing portion is left-to-right riveted on the securing hole, and the positioning portion is borne on the left-to-right disposed step.

8. The secure assembly structure for a furniture hinge buffer device according to claim 7, wherein the movable hinge cup and the positioning member are each provided with the guiding groove, the buffer is provided with the guiding portion and is forward-to-backward slidably positioned on the guiding groove via the guiding portion; wherein the securing hole is disposed on the bottom of an outer side wall of the guiding groove of the movable hinge cup.

9. The secure assembly structure for a furniture hinge buffer device according to anyone of claim 1, wherein the hinge arm is hinged to the movable hinge cup and is provided with an action surface which acts on the buffer at least when the hinge is closed; the positioning member is disposed on the buffer and provided with a damper switch member in a rotation or swinging manner, and a buffer stroke of the damper is restricted and/or restored by rotating or swinging the damper switch member when the hinge is opened and/or closed.

10. The secure assembly structure for a furniture hinge buffer device according to claim 9, wherein the elastic member is a metal torsion spring, one end of the elastic member is disposed on the movable hinge cup, and the other end of the elastic member is crimped on a crimping portion of the hinge arm; a flexible material member is disposed on a region where an intermediate portion of the elastic member is in contact with the movable hinge cup, wherein the flexible material member eliminates the force applied by the intermediate portion of the elastic member onto the movable hinge cup and the noise generated by longitudinal movement of the elastic member relative to the movable hinge cup when the hinge is opened and/or closed.
